(19) United States
(12) Patent Application Publication
(10) Pub. No.: US 2014/0229873 A1
(43) Pub. Date: Aug. 14, 2014

(54) DYNAMIC TOOL CONTROL IN A DIGITAL GRAPHICS SYSTEM USING A VISION SYSTEM

(71) Applicant: COREL CORPORATION, Ottawa (CA)

(72) Inventors: Christopher J. Tremblay, Cantley (CA); Stephen P. Bolt, Stittsville (CA)

(73) Assignee: Corel Corporation, Ottawa (CA)

(21) Appl. No.: 13/766,334

(22) Filed: Feb. 13, 2013

(51) Int. Cl. G06F 3/0484

(52) U.S. Cl. CPC G06F 3/0484
USPC 715/771

(57) ABSTRACT

A system and method for controlling tool selection in a graphics application program executing on a computer are disclosed. The method includes the steps of connecting a vision system to the computer, wherein the vision system is adapted to monitor a visual space. The method further includes the steps of detecting, by the vision system, a tracking object in the visual space, and outputting, by the vision system to the computer, spatial coordinate data representative of the location of the tracking object within the visual space. The method further includes the steps of mapping a horizontal portion and a vertical portion of the spatial coordinate data to a display connected to the computer, and controlling a characteristic of a tool within the tool configuration utility user interface by mapping the spatial coordinate data to a tool control.

### FIELD OF THE INVENTION

This disclosure relates generally to graphic computer software systems and, more specifically, to a system and method for creating and controlling computer graphics and artwork with a vision system.

### BACKGROUND OF THE INVENTION

Graphic software applications provide users with tools for creating drawings for presentation on a display such as a computer monitor or tablet. One such class of applications includes painting software, in which computer-generated images simulate the look of handmade drawings or paintings. Graphic software applications such as painting software can provide users with a variety of drawing tools, such as brush libraries, chalk, ink, and pencils, to name a few. In addition, the graphic software application can provide a ‘virtual canvas’ on which to apply the drawing or painting. The virtual canvas can include a variety of simulated textures.

To create or modify a drawing, the user selects an available input device and opens a drawing file within the graphic software application. Traditional input devices include a mouse, keyboard, or pressure-sensitive tablet. The user can select and apply a wide variety of media to the drawing, such as selecting a brush from a brush library and applying colors from a color panel, or from a palette mixed by the user. Media can also be modified using an optional gradient, pattern, or clone. The user then creates the graphic using a ‘start stroke’ command and a ‘finish stroke’ command. In one example, contact between a stylus and a pressure-sensitive tablet display starts the brushstroke, and lifting the stylus off the tablet display finishes the brushstroke. The resulting rendering of any brushstroke depends on, for example, the selected brush category (or drawing tool); the brush variant selected within the brush category; the selected brush controls, such as brush size, opacity, and the amount of color penetrating the paper texture; the paper texture; the selected color, gradient, or pattern; and the selected brush method.

As the popularity of graphic software applications flourish, new groups of drawing tools, palettes, media, and styles are introduced with every software release. As the choices available to the user increase, so does the complexity of the user interface menu. Graphical user interfaces (GUIs) have evolved to assist the user in the complicated selection processes. However, with the ever-increasing number of choices available, even navigating the GUIs has become time-consuming, and may require a significant learning curve to master. In addition, the GUIs can occupy a significant portion of the display screen, thereby decreasing the size of the virtual canvas.

### SUMMARY OF THE INVENTION

In one aspect of the invention, a method for controlling tool selection in a graphics application program executing on a computer is disclosed. The method includes a step of connecting a vision system to the computer, wherein the vision system is adapted to monitor a visual space. The method further includes the steps of detecting, by the vision system, a tracking object in the visual space, executing, by the computer, a graphics application program, and outputting, by the vision system to the computer, spatial coordinate data representative of the location of the tracking object within the visual space. The method further includes the steps of mapping a horizontal portion and a vertical portion of the spatial coordinate data to a display connected to the computer, and entering a tool configuration utility user interface within the graphics application program. A characteristic of a tool within the tool configuration utility user interface is controlled by mapping the spatial coordinate data to a tool control.

In another aspect of the invention, a graphic computer software system is disclosed. The system includes a computer comprising one or more processors, one or more computer-readable memories, and one or more computer-readable tangible storage devices. The system further includes program instructions stored on at least one of the one or more storage devices for execution by at least one of the one or more processors via at least one of the one or more memories. The system further includes a display connected to the computer, a tracking object, and a vision system connected to the computer. The vision system includes one or more image sensors adapted to capture the location of the tracking object within a visual space. The vision system is adapted to output to the computer spatial coordinate data representative of the location of the tracking object within the visual space. The computer program instructions include program instructions to execute a graphics application program and output to the display, program instructions to map at least a horizontal and vertical portion of the spatial coordinate data of the tracking object as input to a graphics engine of the graphics application program, and program instructions to respond to a command to enter a tool configuration utility within the graphics application program and map the spatial coordinate data to a tool control within the graphics application program.

### BRIEF DESCRIPTION OF THE DRAWINGS

The features described herein can be better understood with reference to the drawings described below. The drawings are not necessarily to scale, emphasis instead generally being placed upon illustrating the principles of the invention. In the drawings, like numerals are used to indicate like parts throughout the various views.

FIG. 1 depicts a functional block diagram of a graphic computer software system according to one embodiment of the present invention;

FIG. 2 depicts a perspective schematic view of the graphic computer software system of FIG. 1;

FIG. 3 depicts a perspective schematic view of the graphic computer software system shown in FIG. 1 according to another embodiment of the present invention;

FIG. 4 depicts a perspective schematic view of the graphic computer software system shown in FIG. 1 according to yet another embodiment of the present invention;

FIG. 5 depicts a schematic front plan view of the graphic computer software system shown in FIG. 1;

FIG. 6 depicts another schematic front plan view of the graphic computer software system shown in FIG. 1;

FIG. 7 depicts a schematic top view of the graphic computer software system shown in FIG. 1;

FIG. 8 depicts an enlarged view of the graphic computer software system shown in FIG. 7; and

FIG. 9 depicts an application window within the graphics application program of the graphic computer software system shown in FIG. 1.

### DETAILED DESCRIPTION OF THE INVENTION

According to various embodiments of the present invention, a graphic computer software system provides a solution to the problems noted above. The graphic computer software system includes a vision system as an input device to track the motion of an object in the vision system's field of view. The output of the vision system is translated to a format compatible with the input to a graphics application program. The object's motion can be used to create brushstrokes, control drawing tools and attributes, and control a palette, for example. As a result, the user experience is more natural and intuitive, and does not require a long learning curve to master.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Program code embodied on a computer-readable medium may be transmitted using any appropriate medium, including but not limited to wireless, wireline, optical fiber cable, RF, etc., or any suitable combination of the foregoing.

Computer program code for carrying out operations of the present invention may be written in any combination of one or more programming languages, including an object oriented programming language such as PHP, Javascript, Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

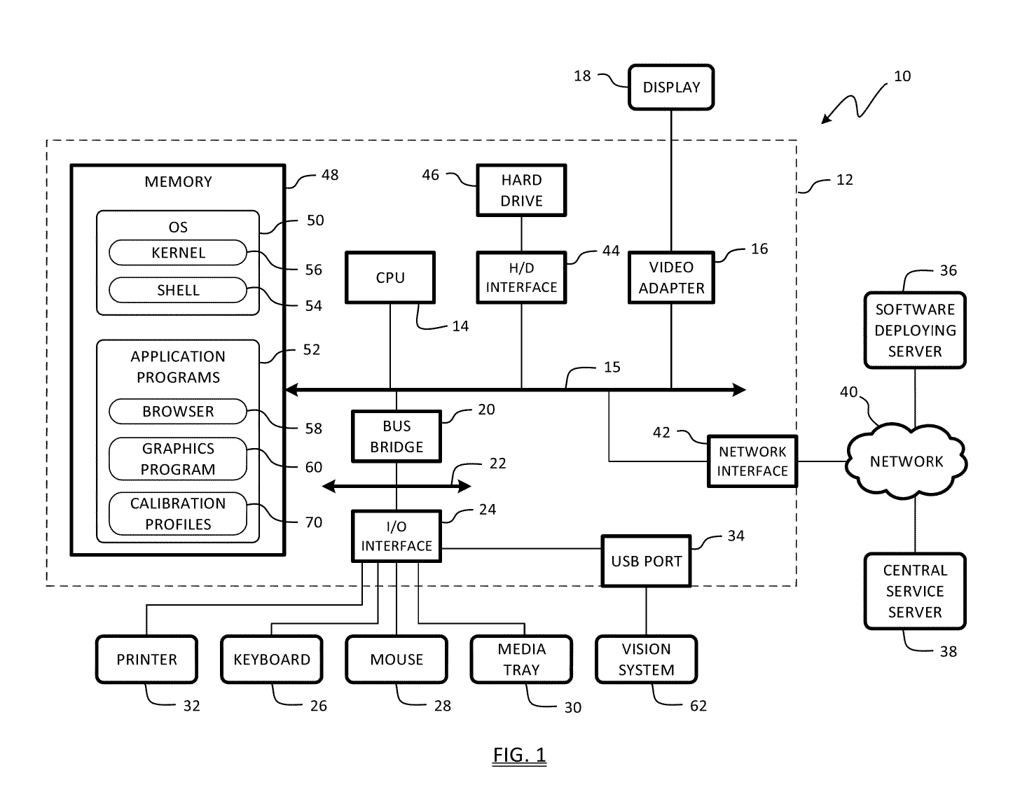

With reference now to the figures, and in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 depicts a block diagram of a graphic computer software system 10 according to one embodiment of the present invention. The graphic computer software system 10 includes a computer 12 having a computer readable storage medium which may be utilized by the present disclosure. The computer is suitable for storing and/or executing computer code that implements various aspects of the present invention. Note that some or all of the exemplary architecture, including both depicted hardware and software, shown for and within computer 12 may be utilized by a software deploying server and/or a central service server.

Computer 12 includes a processor (or CPU) 14 that is coupled to a system bus 15. Processor 14 may utilize one or more processors, each of which has one or more processor cores. A video adapter 16, which drives/supports a display 18, is also coupled to system bus 15. System bus 15 is coupled via a bus bridge 20 to an input/output (I/O) bus 22. An I/O interface 24 is coupled to (I/O) bus 22. I/O interface 24 affords communication with various I/O devices, including a keyboard 26, a mouse 28, a media tray 30 (which may include storage devices such as CD-ROM drives, multi-media interfaces, etc.), a printer 32, and external USB port(s) 34. While the format of the ports connected to I/O interface 24 may be any known to those skilled in the art of computer architecture, in a preferred embodiment some or all of these ports are universal serial bus (USB) ports.

As depicted, computer 12 is able to communicate with a software deploying server 36 and central service server 38 via network 40 using a network interface 42. Network 40 may be an external network such as the Internet, or an internal network such as an Ethernet or a virtual private network (VPN).

A storage media interface 44 is also coupled to system bus 15. The storage media interface 44 interfaces with a computer readable storage media 46, such as a hard drive. In a preferred embodiment, storage media 46 populates a computer readable memory 48, which is also coupled to system bus 14. Memory 48 is defined as a lowest level of volatile memory in computer 12. This volatile memory includes additional higher levels of volatile memory (not shown), including, but not limited to, cache memory, registers and buffers. Data that populates memory 48 includes computer 12's operating system (OS) 50 and application programs 52.

Operating system 50 includes a shell 54, for providing transparent user access to resources such as application programs 52. Generally, shell 54 is a program that provides an interpreter and an interface between the user and the operating system. More specifically, shell 54 executes commands that are entered into a command line user interface or from a file. Thus, shell 54, also called a command processor, is generally the highest level of the operating system software hierarchy and serves as a command interpreter. The shell 54 provides a system prompt, interprets commands entered by keyboard, mouse, or other user input media, and sends the interpreted command(s) to the appropriate lower levels of the operating system (e.g., a kernel 56) for processing. Note that while shell 54 is a text-based, line-oriented user interface, the present disclosure will equally well support other user interface modes, such as graphical, voice, gestural, etc.

As depicted, operating system (OS) 50 also includes kernel 56, which includes lower levels of functionality for OS 50, including providing essential services required by other parts of OS 50 and application programs 52, including memory management, process and task management, disk management, and mouse and keyboard management.

Application programs 52 include a renderer, shown in exemplary manner as a browser 58. Browser 58 includes program modules and instructions enabling a world wide web (WWW) client (i.e., computer 12) to send and receive network messages to the Internet using hypertext transfer protocol (HTTP) messaging, thus enabling communication with software deploying server 36 and other described computer systems.

The hardware elements depicted in computer 12 are not intended to be exhaustive, but rather are representative to highlight components useful by the present disclosure. For instance, computer 12 may include alternate memory storage devices such as magnetic cassettes (tape), magnetic disks (floppies), optical disks (CD-ROM and DVD-ROM), and the like. These and other variations are intended to be within the spirit and scope of the present disclosure.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In one embodiment of the invention, application programs 52 in computer 12's memory (as well as software deploying server 36's system memory) may include a graphics application program 60, such as a digital art program that simulates the appearance and behavior of traditional media associated with drawing, painting, and printmaking.

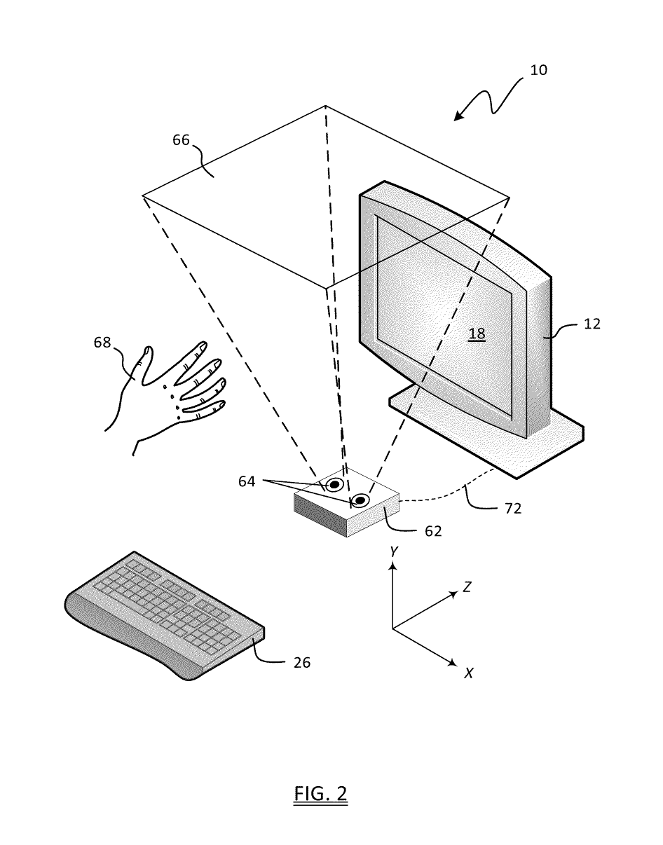

Turning now to FIG. 2, the graphic computer software system 10 further includes a computer vision system 62 as a motion-sensing input device to computer 12. The vision system 62 may be connected to the computer 12 wirelessly via network interface 42 or wired through the USB port 34, for example. In the illustrated embodiment, the vision system 62 includes stereo image sensors 64 to monitor a visual space 66 of the vision system, detect, and capture the position and motion of a tracking object 68 in the visual space. In one example, the vision system 62 is a Leap Motion controller available from Leap Motion, Inc. of San Francisco, Calif.

The visual space 66 is a three-dimensional area in the field of view of the image sensors 64. In one embodiment, the visual space 66 is limited to a small area to provide more accurate tracking and prevent noise (e.g., other objects) from being detected by the system. In one example, the visual space 66 is approximately 0.23 m³ (8 cu.ft.), or roughly equivalent to a 61 cm cube. As shown, the vision system 62 is positioned directly in front of the computer display 18, the image sensors 64 pointing vertically upwards. In this manner, a user may position themselves in front of the display 18 and draw or paint as if the display were a canvas on an easel.

In other embodiments of the present invention, the vision system 62 could be positioned on its side such that the image sensors 64 point horizontally. In this configuration, the vision system 62 can detect a tracking object 68 such as a hand, and the hand could be manipulating the mouse 28 or other input device. The vision system 62 could detect and track movements related to operation of the mouse 28, such as movement in an X-Y plane, right-click, left-click, etc. It should be noted that a mouse need not be physically present—the user's hand could simulate the movement of a mouse (or other input device such as the keyboard 26), and the vision system 62 could track the movements accordingly.

The tracking object 68 may be any object that can be detected, calibrated, and tracked by the vision system 62. In the example wherein the vision system is a Leap Motion controller, exemplary tracking objects 68 include one hand, two hands, one or more fingers, a stylus, painting tools, or a combination of any of those listed. Exemplary painting tools can include brushes, sponges, chalk, and the like.

The vision system 62 may include as part of its operating software a calibration routine 70 in order that the vision system recognizes each tracking object 68. For example, the vision system 62 may install program instructions including a detection process in the application programs 52 portion of memory 48. The detection process can be adapted to learn and store profiles 70 (FIG. 1) for a variety of tracking objects 68. The profiles 70 for each tracking object 68 may be part of the graphics application program 60, or may reside independently in another area of memory 48.

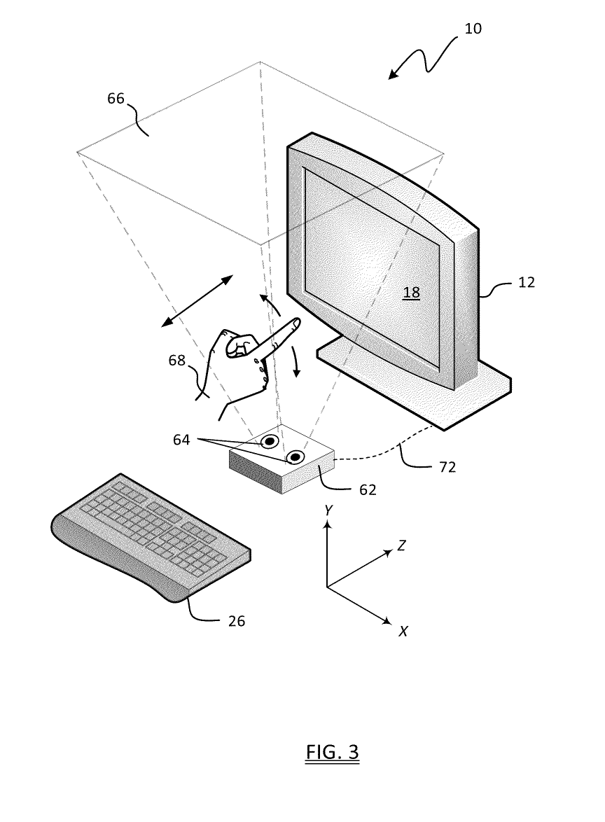

As shown in FIG. 3, insertion of a tracking object 68 such as a finger into the visual space 66 causes the vision system 62 to detect and identify the tracking object, and provide spatial coordinate data 72 to computer 12 representative of the location of the tracking object 68 within the visual space 66. The particular spatial coordinate data 72 will depend on the type of vision system being used. In one embodiment, the spatial coordinate data 72 is in the form of three-dimensional coordinate data and a directional vector. In one example, the three-dimensional coordinate data may be expressed in Cartesian coordinates, each point on the tracking object being represented by (x, y, z) coordinates within the visual space 66. For purposes of illustration and to further explain orientation of certain features of the invention, the x-axis runs horizontally in a left-to-right direction of the user; the y-axis runs vertically in an up-down direction to the user; and the z-axis runs in a depth-wise direction towards and away from the user. In addition to streaming the current (x, y, z) position for each calibrated point or points on the tracking object 68, the vision system 62 can further provide a directional vector D indicating the instantaneous direction of the point, the length and width (e.g., size) of the tracking object, the velocity of the tracking object, and the shape and geometry of the tracking object.

Traditional graphics application programs utilize a mouse or pressure-sensitive tablet as an input device to indicate position on the virtual canvas, and where to begin and end brushstrokes. In the case of a mouse as an input device, the movement of the mouse on a flat surface will generate planar coordinates that are fed to the graphics engine of the software application, and the planar coordinates are translated to the computer display or virtual canvas. Brushstrokes can be created by positioning the mouse cursor to a desired location on the virtual canvas and using mouse clicks to indicate start brushstroke and stop brushstroke commands. In the case of a tablet as an input device, the movement of a stylus on the flat plane of the tablet display will generate similar planar coordinates. In some tablets, application of pressure on the flat display can be used to indicate a start brushstroke command, and lifting the stylus can indicate a stop brushstroke command. In either case, the usefulness of the input device is limited to generating planar coordinates and simple binary commands such as start and stop.

In contrast, the spatial coordinate data 72 of the vision system 62 can be adapted to provide coordinate input to the graphics application program 60 in three dimensions, as opposed to only two. The three dimensional data stream, the directional vector information, and additional information such as the width, length, size, velocity, shape and geometry of the tracking object can be used to enhance the capabilities of the graphics application program 60 to provide a more natural user experience.

In one embodiment of the present invention, the (x, y) portion of the position data from the spatial coordinate data 72 can be mapped to (x′, y′) input data for a painting application program 60. As the user moves the tracking object 68 within the visual space 66, the (x, y) coordinates are mapped and fed to the graphics engine of the software application, then ‘drawn’ on the virtual canvas. The mapping step involves a conversion from the particular coordinate output format of the vision system to a coordinate input format for the painting application program 60. In one embodiment using the Leap Motion controller, the mapping involves a two-dimensional coordinate transformation to scale the (x, y) coordinates of the visual space 66 to the (x′, y′) plane of the virtual canvas.

The (z) portion of the spatial coordinate data 72 can be captured to utilize specific features of the graphics application program 60. In this manner, the (x, y) coordinates could be utilized for a position database and the (z) coordinates could be utilized for another, separate database. In one example, depth coordinate data can provide start brushstroke and stop brushstroke commands as the tracking object 68 moves through the depth of visual space 66. The tracking object 68 may be a finger or a paint brush, and the graphics application program 60 may be a digital paint studio. The user may prepare to apply brush strokes to the virtual canvas by inserting the finger or brush into the visual space 66, at which time spatial coordinate data 72 begins streaming to the computer 12 for mapping, and the tracking object appears on the display 18. The brushstroke start and stop commands may be initiated via keyboard 26 or by holding down the left-click button of the mouse 28. In one embodiment of the invention, the user moves the tracking object 68 in the z-axis to a predetermined point, at which time the start brushstroke command is initiated. When the user pulls the tracking object 68 back in the z-axis past the predetermined point, the stop brushstroke command is initiated and the tracking object “lifts” off the virtual canvas.

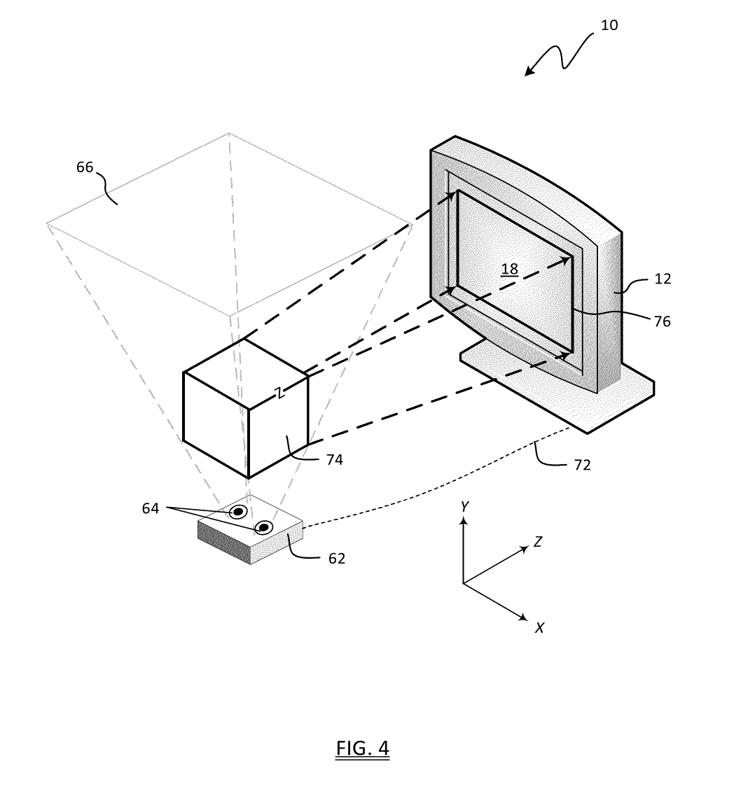

In another embodiment of the invention, a portion of the visual space can be calibrated to enhance the operability with a particular graphics application program. Turning to FIG. 4, the vision system mapping function can include defining a calibrated visual space 74 to provide a virtual surface 76 on the display 18. The virtual surface 76 correlates to the virtual canvas on the painting application program 60. The virtual surface 76 can be represented by the entire screen, a virtual document, a document with a boundary zone, or a specific window, for example. The calibrated visual space 74 can be established by default settings (e.g., ‘out of the box’), by specific values input and controlled by the user, or through a calibration process. In one example, a user can conduct a calibration by indicating the eight corners of the desired calibrated visual space 74. The corners can be indicated by a mouse click, or by a defined gesture with the tracking object 68, for example.

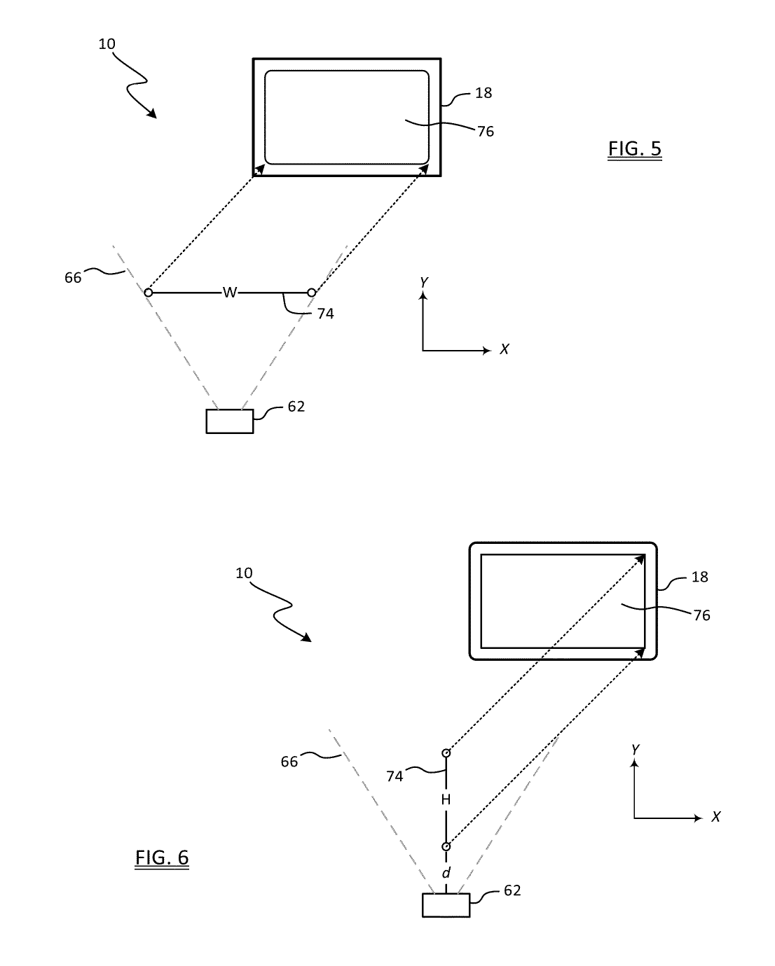

FIG. 5 depicts a schematic front plan view of a calibrated horizontal position 74 in the visual space 66 mapped to the horizontal position in the virtual surface 76. The mapping system may allow control of how much displacement (W) is needed to reach the full virtual surface extents, horizontally. In a typical embodiment, a horizontal displacement (W) of approximately 30 cm (11.8 in.) with a tracking object in the visual space 66 will be sufficient to extend across the entire virtual surface 76. However, the user can select a smaller amount of horizontal displacement if they wish, for example 10 cm (3.9 in.). The center position can also be offset within the visual space, left or right, if desired.

FIG. 6 depicts a schematic front plan view of a calibrated vertical position 74 in the visual space 66 mapped to the vertical position in the virtual surface 76. The mapping system may allow control of how much displacement (H) is needed to reach the full virtual surface extents, vertically. In a typical embodiment, a vertical displacement (H) of approximately 30 cm (11.8 in.) with a tracking object in the visual space 66 will be sufficient to extend across the entire virtual surface 76. The calibrated position 74 may further include a vertical offset (d) from the vision system 62 below which input objects will be ignored. The offset can be defined to give a user a comfortable, arm's length position when drawing.

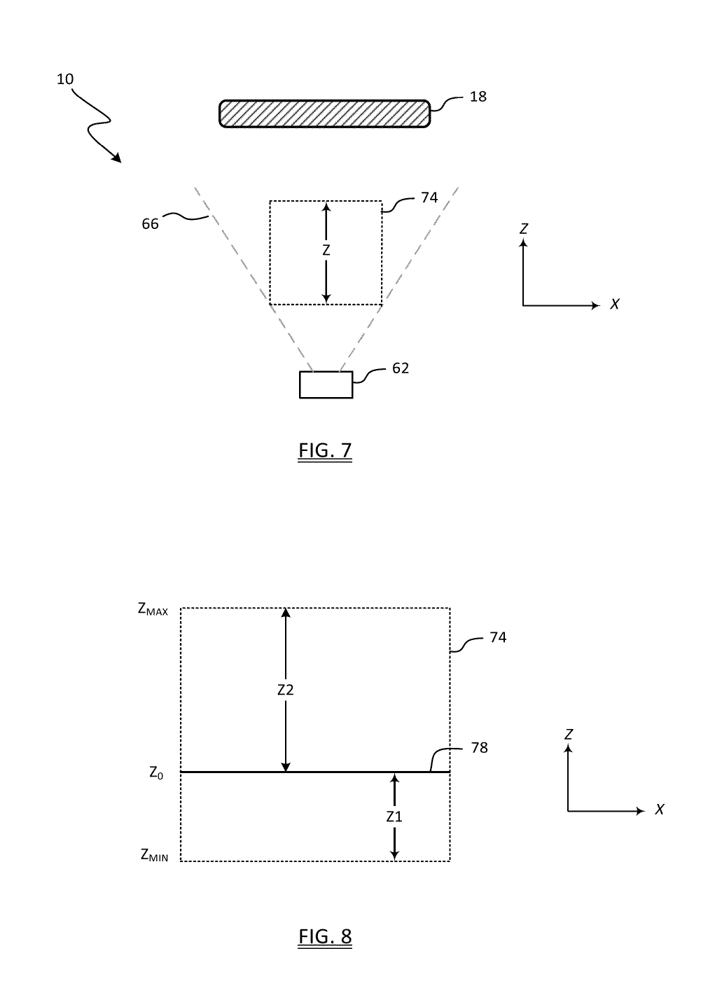

FIG. 7 depicts a schematic top view of a calibrated depth position 74 in the visual space 66. The calibrated depth position 74 can be calibrated by any of the methods described above with respect to the height (H) and width (W). The depth (Z) of the tracking object 68 in the visual space 66 is not required to map the object in the X-Y plane of the virtual surface 76, and the (z) coordinate data 72 can be useful for a variety of other functions.

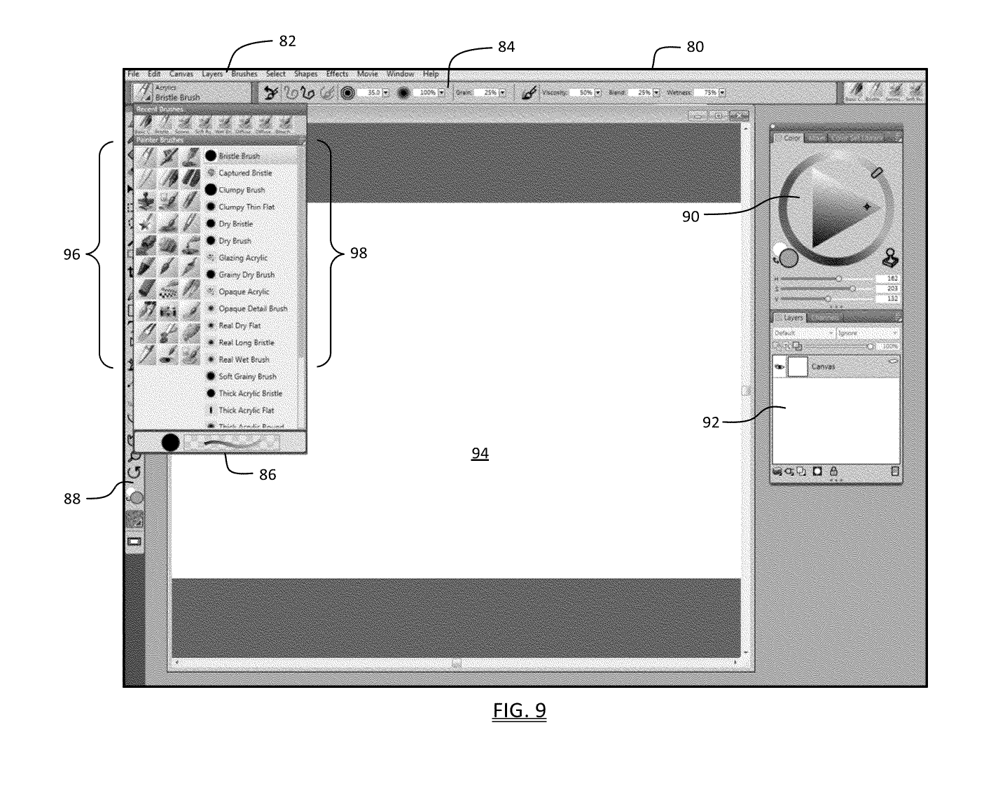

FIG. 8 depicts an enlarged view of the calibrated depth position 74 shown FIG. 7. The calibrated depth position 74 can include a center position Z₀, defining opposing zones Z₁ and Z₂. The zones can be configured to take different actions in the graphics application program. In one example, the depth value may be set to zero at center position Z₀, then increase as the tracking object moves towards the maximum (Z_{MAX}), and decrease as the object moves towards the minimum (Z_{MIN}). The scale of the zones can be different when moving the tracking object towards the maximum depth as opposed to moving the object towards the minimum depth. As illustrated, the depth distance through zone Z₁ is less than Z₂. Thus, a tracking object moving at roughly constant speed will pass through zone Z₁ in a shorter period of time, making an action related to the depth of the tracking object appear quicker to the user.

Furthermore, the scale of the zones can be non-linear. Thus, the mapping of the (z) coordinate data in the spatial coordinate data 72 is not a scalar, it may be mapped according to a quadratic equation, for example. This can be useful when it is desired that the rate of depth change accelerates as the distance increases from the central position.

Continuing with the example set forth above, wherein the tracking object 68 is a finger or a paint brush, and the graphics application program 60 may be a digital paint studio, the user may prepare to apply brush strokes to the virtual canvas by inserting the finger or brush into the visual space 66, at which time spatial coordinate data 72 begins streaming to the computer 12 for mapping, and the tracking object appears on the display 18. As the user approaches the virtual canvas 76, the tracking object passes into zone Z₁ and the object may be displayed on the screen. As the tracking object passes Z₀, which may signify the virtual canvas, a start brushstroke command is initiated and the finger or brush “touches” the virtual canvas and begins the painting or drawing stroke. When the user completes the brushstroke, the tracking object 68 can be moved in the z-axis towards the user, and upon passing Z₀ the stop brushstroke command is initiated and the tracking object “lifts” off the virtual canvas.

In another embodiment of the invention, the depth or position on the z-axis can be mapped to any of the brush's behaviors or characteristics. In one example, zone Z₂ can be configured to apply “pressure” on the tracking object 68 while painting or drawing. That is, once past Z₀, further movement of the tracking object into the second zone Z₂ can signify the pressure with which the brush is pressing against the canvas; light or heavy. Graphically, the pressure is realized on the virtual canvas by converting the darkness of the paint particles. A light pressure or small depth into zone Z₂ results in a light or faint brushstroke, and a heavy pressure or greater depth into zone Z₂ results in a dark brushstroke.

In some applications, the transformation from movement in the vision system to movement on the display is linear. That is, a one-to-one relationship exists wherein the amount the object is moving is the same amount of pixels that are displayed. However, certain aspects of the present invention can apply a filter of sorts to the output data to accelerate or decelerate the movements to make the user experience more comfortable.

In yet another embodiment of the invention, non-linear scaling can be utilized in mapping the z-axis to provide more realistic painting or drawing effects. For example, in zone Z₂, a non-linear coordinate transformation could result in the tracking object appearing to go to full pressure slowly, which is more realistic than linear pressure with depth. Conversely, in zone Z₁, a non-linear coordinate transformation could result in the tracking object appearing to lift off the virtual canvas very quickly. These non-linear mapping techniques could be applied to different lengths of zones Z₁ and Z₂ to heighten the effect. For example, zone Z₁ could occupy about one-third of the calibrated depth 74, and zone Z₂ could occupy the remaining two-thirds. The non-linear transformation would result in the zone Z₁ action appearing very quickly, and the zone Z₂ action appearing very slowly.

The benefit to using non-linear coordinate transformation is that the amount of movement in the z-axis can be controlled to make actions appear faster or slower. Thus, the action of a brush lifting up could be very quick, allowing the user to lift up only a small amount to start a new stroke.

In the illustrated embodiments, and FIG. 8 in particular, only two zones are disclosed. However, any number of zones having differing functions can be incorporated without departing from the scope of the invention. In this regard, the calibrated visual space 74 may include one or more control planes 78 to separate the functional zones. In FIG. 8, control plane Z₀ is denoted by numeral 78.

In other embodiments of the invention, the (z) portion of the position data from the spatial coordinate data 72 can be captured to utilize software application tools that are used ‘off-canvas’ for the user; that is, the tools used by digital artists that don't actually touch the canvas. Thus, the (x, y, z) portion of the output data 72 can be useful for not only the painting process, but also in making selections. In terms of database storage, the (x, y) coordinates could be utilized for a position database and the (z) coordinates could be utilized for another, separate database, such as a library. The library could be a collection of different papers, patterns, or brushes, for example, and could be accessed by moving the tracking object 68 through control planes in the z-axis to go to different levels on the library database.

FIG. 9 depicts a typical application window 80 of a graphics application program, such as a digital art studio, according to one embodiment of the invention. The primary elements of the application window include a menu bar 82 to access tools and features using a pull-down menu; a property bar 84 for displaying commands related to the active tool or object; a brush library panel 86; a toolbox 88 to access tools for creating, filling, and modifying an image; a temporal color palette 90 to select a color; a layers panel 92 for managing the hierarchy of layers, including controls for creating, selecting, hiding, locking, deleting, naming, and grouping layers; and a virtual canvas 94 on which the graphic image is created. The canvas 94 may include media such as textured paper, fabrics, and wood grain, for example.

The brush library panel 86 displays the available brush libraries 96 on the left-hand side of the panel. As illustrated, there are 30 brush libraries 96 ranging alphabetically from Acrylics at top left to Watercolor at bottom right. Selecting any one of the 30 brush libraries, by mouse-clicking its icon for example, brings up a brush selection 98 from the currently selected brush library. In the illustrated example, there are 22 brush selections 98 from the Acrylic library 96. In total, there may be more than 700 brush styles from which a user may select.

Although such a vast selection of brushes can allow a user to create virtually any painting media desired, the selection process can be time-consuming and may actually discourage or dampen the artistic spirit of a user. Some graphics application programs display recently used brushes, but these are of little use in the selection of new or experimental brush media.

According to one embodiment of the current invention, a characteristic of a tool within the graphics application program 60 can be dynamically controlled with the spatial coordinate data 72 output by a tracking object 68 in the visual space 66 of the vision system 62. As used herein, the term “tool” is meant to include not only drawing tools such as brushes and the like, but any feature selectable and controlled by the user. Other exemplary tools include, but are not limited to, the color palette, layers, the canvas, the toolbox and associated commands, menus, and graphical user interfaces (GUIs).

Example 1: The position of the tracking object 68 can be used to control one or more tool parameters. One embodiment, described above, is to map the (x, y) coordinates of the tracking object 68 to control the (x′, y′) position of the tool (e.g., paint brush) on the virtual canvas 94.

Example 2: The orientation of the tracking object 68 can be used to control one or more tool parameters. The vision system 62 can be calibrated or otherwise adapted to recognize a plurality of points on a given tracking object 68, the size of the tracking object, or the shape and geometry of the tracking object. In this manner, a general shape or outline of each tracking object 68 can be exported to the computer 12 as three-dimensional coordinate data, and the data can be processed to calculate if the tracking object 68 is straight or tilted, or if the tracking object 68 matches pre-defined profiles 70 such as hand gestures.

In some painting applications, the degree of tilt is a brush parameter that can be set by way of a pulling up a menu and adjusting a slider bar, typically between 0 and 90 degrees. The brushstroke will appear as though the tool was tilted at the defined angle, which has a pronounced effect when using an airbrush. Other similar parameters that can be changed include the pressure on the brush, and the bearing (the compass direction in which the tool is pointing).

In one example, the (x, y) coordinates of the spatial coordinate data 72 from the vision system 62 can be used to dynamically adjust the tilt and bearing settings in the graphics application program 60, simply by orienting the tracking object 68. Further, the (z) coordinates of the spatial coordinate data 72 can be used to adjust the pressure setting; moving the tracking object 68 in and out increases and decreases the pressure setting.

As noted above, the spatial coordinate data 72 from the vision system 62 could further include directional vector data. In one example, the directional vector data is a palm vector that indicates the orientation of a user's palm. The palm vector could be used, for example, to enhance tools such as sponges, or larger objects used in the graphics application program 60. The spatial coordinate data 72 could be used to simulate a user holding that object and interacting with the graphics application program 60. Because the orientation of the object can be determined from the spatial coordinate data 72, the graphics application program 60 could dab a corner of a sponge tool as it touches down on the canvas 94. Or, the program 60 could simulate putting down the side edge, or the whole face of the sponge onto the canvas 94.

In another example, the directional vector data could be associated with the orientation of the tracking object 68, such as the directional pointing of a finger, tool, palm, or hand orientation. In one implementation for use in a painting program, the direction of the spray of an airbrush could be based on the tilt and angular orientation (bearing) provided by the finger orientation.

In another example, the tracking object 68 could be a hand, and pre-defined hand gestures could bring up certain menus in the graphics application program 60. In one embodiment, a library of hand gestures 70 (FIG. 1) could be created for the vision system 62, and each hand gesture within the visual space 66 could be associated with an on-screen menu or GUI. For example, the hand gesture could be an open hand or a closed hand to bring up the UI screen, at which point the user could then begin to interact with the selection.

Example 3: The depth of the tracking object 68 in the visual space 66 can be used to control one or more tool parameters. As described above, the (z) coordinates of the spatial coordinate data 72 can provide start brushstroke and stop brushstroke commands as the tracking object 68 moves through the depth of visual space 66.

In another embodiment disclosed above, the visual space 66 can include a calibrated visual space 74 which can be divided into one or more control planes 78 to separate functional zones. In one example, the control planes 78 are in the z-axis, and the mapping to the computer 12 may be non-linear to achieve accelerated or decelerated effects on the virtual canvas 94.

The depth information can be used to control a variety of tool parameters such as brush size, opacity, grain, viscosity of the paint, and wetness of the paint, for example. In prior art painting programs, such as that illustrated in the application window 80 of FIG. 9, some of these parameters can be found in the property bar 84. Others require opening a new menu or GUI, which either decreases the size of the canvas 94 or overlaps it. A further constraint is that these parameters are typically set to a constant value during the brushstroke. In other words, the settings are static. In contrast, embodiments of the present invention can associate these parameters with the depth information available from the tracking object 68. The tracking object 68 can be moved in and out of the z-axis, for example, which could have the same effect as moving the slider from 0% to 100%. In this manner, the disclosed graphic computer software system 10 can allow one or more of the parameters to be adjusted dynamically during the brushstroke (e.g., real-time, or ‘on the fly’).

The ability to control opacity, or degree of transparency, is particularly important in graphics application programs. As noted, some prior art software programs permit selecting opacity using a graphic slider scale, but this method is a static selection. One of the improvements of the present invention is the ability to dynamically control opacity. Further, the change in opacity (e.g., 0% to 100%) can be mapped in a non-linear manner. A constant rate of movement by the tracking object 68 through the calibrated visual space 74 can result in an accelerated (or decelerated) change in opacity on the display 18.

The depth information can also be used to control the pressure parameter, such as the pressure of the brush on the virtual canvas 94, or the paint pressure in an airbrush application. Some prior art graphics application programs use a slider bar to control the pressure parameter, which is a static setting. However, associating the pressure parameter with the depth information 72 available from the tracking object 68 allows the pressure to be adjusted dynamically during the brushstroke. The artistic result can be dramatic: using a textured paper and chalk for example, light pressure will just barely brush the surface and accentuate the texture, moderate pressure will show darker color and the paper texture, and full pressure will fill almost all the paper texture. The present invention can allow all these settings in one brushstroke with the tracking object 68.

In one embodiment of the invention, different control planes 78 in the calibrated visual space 74 could be used to set up a workspace for a new drawing. Referring back to FIG. 8, in one example, moving a tracking object 68 such as a hand into a first depth zone Z₁ could bring up the paper selection user interface (UI). Within zone Z₁, movement to the right or left (e.g., along the x-axis) could display the different paper styles. The paper style could be selected by a movement in the vertical direction (e.g., along the y-axis), by a keyboard command, or a hand gesture, for example. Further movement into a second depth zone Z₂ could bring up the brush libraries 96, and right or left movement could display the brush selections 98 (FIG. 9). Still further movement into a third depth zone (not shown) could allow the user to select characteristics or parameters specific to the chosen brush style.

Example 4: Multiple tracking objects could be utilized to control one or more tool parameters. In one embodiment of the invention, more than one tracking object 68 can be used to make the selection of tool parameters feel more natural. In one example, a user's left hand could be used as a gesture interface to bring up a specific tool such as a brush, and the right hand could be used in the z-axis to make the selection, such as the particle amount, size, or opacity. In another example, two tracking objects 68 such as hands could be used as a single control, such as a color selection. One hand could control the hue, and the other hand could control the saturation and value.

In another example, one hand could invoke the color palette user interface 90, and the other hand could control either the outer hue ring or the inner color triangle of the color palette. The decision whether to control the hue ring or the color triangle (or to toggle between them) could be determined from a configuration and/or a gesture of either the hand that invoked the user interface, or the hand interacting with the user interface 90. The configuration/gesture could be, for example, the number of fingers shown, the detected hand pose, or the presence (or lack of presence) of a tool in the hand.

In another embodiment, multiple tracking objects could each be assigned different behaviors. For example, each tracking object could be assigned to control different brushes (e.g., chalk, pencil, brush) at the same time, or each object could be assigned different tool parameters (e.g., each tracking object could have different colors, opacity, size, etc.). In one implementation, a user could paint with two fingers, each finger having a different color brush stroke. In another implementation, each tracking object could control different brush parameters. A first tracking object could create a stroke, the opacity of which could be controlled by the depth of the object in z-axis. A second tracking object could create a different stroke, the color of which could be controlled by the depth of the second object in z-axis. The actual selection of the brush or brush parameter assigned to each tracking object could be based on, for example, the object's position from the center of the hand; randomly; in the order in which the tracking object was detected; sorted sequentially from left to right; up-down; the distance from an arbitrary point in the visual space; or the depth in the z-axis.

Example 5: The distance between tracking inputs could be used to control one or more tool parameters. In one embodiment, the processor could execute program instructions to determine the distance between two tracking objects, such as two fingers, and the calculated distance could be mapped to a tool selection or parameter. For example, a user could select a brush, and use the distance between the user's thumb and forefinger to define a brush parameter, such as amount of particles, size, or opacity. The selections or gestures could be assignable by the user.

In another embodiment, the processor could execute program instructions to determine the distance between two tracking objects and a reference point, such as the center of the user's hand. Distance information could be calculated between each tracking object and the reference point, and used to control one or more tool parameters. Alternatively, the distance between two tracking objects and a reference point could be used in combination with the distance computation between two tracking inputs.

In another embodiment, multiple or additional drawing (or painting) strokes could be created based on the configuration of the tracking objects, and/or the distance between tracking objects. In one example, each tracking object (such as index finger, middle finger, and thumb) could invoke a unique/independent brush stroke. Furthermore, in another embodiment, each tracking object could invoke their own stroke, and additional brush marks or strokes could be created based on the configuration of the tracking object. For example, additional strokes could be created to connect the individual strokes. The opacity or presence of the connections could be based on the distance between the tracking objects. The connections could be straight lines, curves, or any other type of stroke.

In another embodiment, each tracking object may not create their own stroke, but additional brush marks could be created based on the configuration of the tracking objects. The additional brush marks need not be connections, either. For example, they could be orbits around each of the tracking object trajectories, and the radius of the orbit could be based on the distance between the multiple tracking objects.

Example 6: The type, size and shape of tracking object could be used to select a tool (e.g., brush, smudge, spray can, rotate tool, etc.), or to control one or more tool parameters (e.g., size, color, behavior, etc.). In one embodiment, the length or width of the tracking object can be used to control different parameters. In one example, the brush size can be based on the size or shape of the tracking object, or the size or shape of the tracking object could be used to switch between tools. The pattern recognition software associated with the vision system can discern between a finger and another object or objects. In one embodiment then, a user's finger in the visual space could select a smudge tool, and a marker in the visual space could switch to a marker tool. The graphic computer software system could switch to different brushes or tools based on shape or number or type of tracking objects.

In another example, the graphics application program may provide visual feedback as to the tool that is about to be selected. The tool may be visualized to the user, the user confirms they want to switch to that tool or brush (by taking no action, in one example), then the selection remains and the user begins painting with it.

In another example, the shape of the tracking object could be used to select variants of a tool, such as a brush selection from the brush library. The distance between fingers on the hand could define brush selections, such as a bristle brush for fingers spread wide, or a pencil for fingers grouped close together. Or, the tracking object such as a hand could temporarily become the brush for the user to reconfigure the shape of that brush. Different shapes or gestures could denote particular selections.

Example 7: The velocity of the tracking object, such as finger tips, can be used to control one or more tool parameters. One exemplary vision system, such as the Leap Motion controller, provides velocity information of the tracking object. Thus, the velocity information could be utilized to control the brush size, opacity, etc.

Example 8: In one embodiment of the invention, any of the above examples and embodiments could be combined together to control one or more tool parameters, such as position, orientation, depth, number of tracking objects, distance between tracking objects, distance between tracking objects and a reference position, type, size, shape, or velocity. For example, depth in the z-axis can be used to control brush size and opacity; and color, all at once. In another embodiment of the invention, any of the above examples and embodiments could be combined together to determine which tool to operate with, such as position, orientation, depth, number of tracking objects, distance between tracking objects, distance between tracking objects and a reference position, type, size, or shape.

In one example, a first hand could be used to control tool parameters, and a second hand could be used to control position. In one implementation, a tool parameter such as brush size could be controlled by, for example, openness of one hand; distance between tracking objects; or the depth in the z-axis. The second hand could be used to locate a position on the virtual canvas where the brush stroke is to be applied.

In another implementation, a first hand could be used to control tool parameters (as above), but a different input device (e.g., mouse, or tablet) could be used to control position.

In yet another implementation, a first hand could be used to point to a position on the virtual canvas where the brush stroke is to be applied, and a different input method such as a pressure-sensitive tablet could be used to control the brush parameters (such as brush size).

In yet another implementation, combinations of hand and other inputs could be used to control both brush parameters and positions. For example, tablet pressure and depth in the z-axis could be taken together to control the size of the brush. The system could use the average of the other input means to combine the data, while the user could use their finger or tablet to control the position.

While the present invention has been described with reference to a number of specific embodiments, it will be understood that the true spirit and scope of the invention should be determined only with respect to claims that can be supported by the present specification. Further, while in numerous cases herein wherein systems and apparatuses and methods are described as having a certain number of elements it will be understood that such systems, apparatuses and methods can be practiced with fewer than the mentioned certain number of elements. Also, while a number of particular embodiments have been described, it will be understood that features and aspects that have been described with reference to each particular embodiment can be used with each remaining particularly described embodiment.

What is claimed is:

1. A method for controlling tool selection in a graphics application program executing on a computer, comprising the steps of:
connecting a vision system to the computer, the vision system adapted to monitor a visual space;
detecting, by the vision system, a tracking object in the visual space;
executing, by the computer, a graphics application program;
outputting, by the vision system to the computer, spatial coordinate data representative of the location of the tracking object within the visual space;
mapping a horizontal portion and a vertical portion of the spatial coordinate data to a display connected to the computer;
entering a tool configuration utility user interface within the graphics application program; and
controlling a characteristic of a tool within the tool configuration utility user interface by mapping the spatial coordinate data to a tool control.

2. The method according to claim 1, wherein the mapped spatial coordinate data comprises a horizontal and a vertical portion of the spatial coordinate data, a depth portion of the spatial coordinate data, or both.

3. The method according to claim 1, wherein the detecting step comprises calculating if the tracking object matches a pre-defined profile, and the controlling step comprises adjusting a tilt angle value in response to a comparison between the spatial coordinate data and the pre-defined profile.

4. The method according to claim 1, wherein the controlling step comprises mapping a depth portion of the spatial coordinate data to a start brushstroke command and a pressure value of the tracking object on a virtual canvas.

5. The method according to claim 1, wherein the controlling step comprises mapping a depth portion of the spatial coordinate data to an opacity value of the tool.

6. The method according to claim 1, wherein the step of entering a tool configuration utility user interface comprises gesturing with a tracking object.

7. The method according to claim 1, wherein the detecting step comprises detecting a plurality of tracking objects, and the controlling step comprises bringing up a tool user interface with a first tracking object, and controlling a characteristic of the tool with a second tracking object.

8. The method according to claim 7, wherein the tool user interface is brought up with a hand gesture, and the spatial coordinate data of the second tracking object is mapped to the tool control.

9. The method according to claim 1, wherein the detecting step comprises detecting a plurality of tracking objects, and the controlling step comprises calculating a distance between the tracking objects and mapping the distance value to a tool control.

10. A digital graphics computer system, comprising:
a computer, comprising:
one or more processors;
one or more computer-readable memories;
one or more computer-readable tangible storage devices; and
program instructions stored on at least one of the one or more storage devices for execution by at least one of the one or more processors via at least one of the one or more memories;
a display connected to the computer;
a tracking object; and
a vision system connected to the computer, the vision system comprising one or more image sensors adapted to capture the location of the tracking object within a visual space, the vision system adapted to output to the computer spatial coordinate data representative of the location of the tracking object within the visual space;
the computer program instructions comprising:
program instructions to execute a graphics application program and output to the display;
program instructions to map at least a horizontal and vertical portion of the spatial coordinate data of the tracking object as input to a graphics engine of the graphics application program; and
program instructions to respond to a command to enter a tool configuration utility within the graphics application program and map the spatial coordinate data to a tool control within the graphics application program.

11. The digital graphics computer system of claim 10, further comprising program instructions to calculate if the tracking object matches a pre-defined profile, and if so, adjusting a tilt angle value in response to a comparison between the spatial coordinate data and the pre-defined profile.

12. The digital graphics computer system of claim 10, further comprising program instructions to divide the visual space into a plurality of zones delineated by one or more control planes, initiate a start brushstroke command when the tracking object crosses the control plane from a first zone to a second zone, and initiate a stop brushstroke command when the tracking object crosses the control plane from the second zone to the first zone.

13. The digital graphics computer system of claim 10, further comprising program instructions to map a depth portion of the spatial coordinate data to an opacity value of the tool control.

14. The digital graphics computer system of claim 10, wherein the vision system is adapted to capture the location of a plurality of tracking objects within the visual space, and further comprising program instructions to bring up a tool user interface with a first tracking object, and control a characteristic of the tool with a second tracking object.

15. The digital graphics computer system of claim 10, wherein the vision system is adapted to capture the location of a plurality of tracking objects within the visual space, and further comprising program instructions to calculate a distance between the tracking objects and map the distance value to a tool control.
